(19) United States
(12) Patent Application Publication
(10) Pub. No.: US 2025/0088912 A1
(43) Pub. Date: Mar. 13, 2025

(54) MINIMIZATION OF INTER RADIO ACCESS TECHNOLOGY TRANSITIONS

(71) Applicant: T-Mobile Innovations LLC, Overland Park, KS (US)

(72) Inventors: Roopesh Kumar POLAGANGA, Bothell, WA (US); Amembal Vikram PAI, Bothell, WA (US); Samir PATEL, Plano, TX (US); Meenakshi DHAR, Bellevue, WA (US)

(21) Appl. No.: 18/462,720

(22) Filed: Sep. 7, 2023

(51) Int. Cl. H04W 36/00; H04W 36/24

(52) U.S. Cl. CPC H04W 36/00222; H04W 36/24

(57) ABSTRACT

Systems, methods and devices are provided for minimizing unnecessary inter-radio access technology (IRAT) transitions. A method includes determining that a wireless device has experienced a threshold number IRAT handovers in a predetermined time period, identifying a trigger for the inter-RAT handovers and assigning the wireless device to a selected RAT based on the identified trigger.

### TECHNICAL BACKGROUND

A wireless network, such as a cellular network, can include an access node (e.g., base station) serving multiple wireless devices or user equipment (UE) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR)) and 6G RATs. Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages. For example, 5G networks provide edge deployments enabling computing capabilities closer to UEs.

With introduction of 5G Standalone (SA) networks, wireless devices may now be able to connect to two independent RATs, depending on their coverage and usage. Wireless devices may be subject to inter-RAT (IRAT) handovers, for example from 5GSA to 4G LTE when they move outside of SA coverage. Further, because 4G or LTE is a more mature RAT than 5G and thus provides additional services, wireless devices may be subject to IRAT handovers when they are connected to 5GSA and need services like voice that are not yet universally available in 5GSA. Each IRAT handover comes with some interruption in service due to required call flow procedures across two different RATs.

Further, scenarios exist in which wireless devices engage in ping-pongs across both 4GLTE and 5GNR by performing continuous IRAT handovers. These scenarios may include, for example, being on a 5GSA coverage edge, using services such as voice that are not universally available on the 5GSA network, network misconfigurations in the access nodes, and specific original equipment manufacturer (OEM) implementations for the wireless devices when they are connected to Wi-fi. Such scenarios could result in increased capacity requirements for the core network due to the intensive resource usage required for IRAT transitions. The excessive IRAT transitions also results in poor user experience.

Hence, a need exists for minimizing IRAT transitions. Accordingly, improvements are provided herein that overcome the above-described deficiencies in order to minimize unnecessary IRAT transitions.

### Overview

Exemplary embodiments described herein include systems, methods, and processing nodes for minimizing unnecessary IRAT transitions. A method includes determining that a wireless device has experienced a threshold number of inter-radio access technology (RAT) handovers in a predetermined time period. Upon making this determination, the method identifies a trigger for the IRAT handovers and assigns the wireless device to a selected RAT based on the identified trigger. In embodiments provided herein, the IRAT transition is deemed unnecessary when the wireless device is determined to be stationary through the course of a threshold number of IRAT transitions.

An additional exemplary embodiment includes a system for minimizing unnecessary IRAT handovers. The system includes a memory storing data and instructions and a processor accessing the stored data and instructions. The processor executes the instructions to perform multiple operations. The operations include determining that a wireless device has experienced a threshold number of inter-radio access technology (RAT) handovers in a predetermined time period. Upon making this determination, the operations further include identifying a trigger for the inter-RAT handovers, wherein the trigger is identified from one of unavailability of a service, signal conditions, and a wireless device model. The operations further include assigning the wireless device to a selected RAT based on the identified trigger.

In yet additional embodiments, a non-transitory computer-readable medium storing instructions for execution by a processor is provided. Upon execution, the instructions cause multiple operations to be executed. The operations include determining that a wireless device has experienced a threshold number of inter-radio access technology (RAT) handovers in a predetermined time period and identifying a trigger for the inter-RAT handovers. The operations further include assigning the wireless device to a selected RAT based on the identified trigger.

### BRIEF DESCRIPTION OF THE DRAWINGS

FIG. 1 depicts an exemplary operating environment system for employing an inter radio access technology (IRAT) transition controller in accordance with the disclosed embodiments.

FIG. 2 illustrates an additional exemplary operating environment for an IRAT transition controller in accordance with disclosed embodiments.

FIG. 3 illustrates an exemplary configuration for an IRAT transition controller in accordance with disclosed embodiments.

FIG. 4 depicts an exemplary access node in accordance with disclosed embodiments.

FIG. 5 depicts an exemplary wireless device in accordance with the disclosed embodiments.

FIG. 6 depicts an exemplary method for minimizing unnecessary IRAT transitions in accordance with disclosed embodiments.

FIG. 7 depicts a further exemplary method for minimizing unnecessary IRAT transitions in accordance with disclosed embodiments.

FIG. 8A depicts a further exemplary method for minimizing unnecessary IRAT transitions in accordance with disclosed embodiments.

FIG. 8B depicts further details of the exemplary method of FIG. 8A for minimizing unnecessary IRAT transitions in accordance with disclosed embodiments.

FIG. 9 depicts a further exemplary method for minimizing unnecessary IRAT transitions in accordance with disclosed embodiments.

### DETAILED DESCRIPTION

Exemplary embodiments described herein include systems and methods for minimizing inter radio access technology (IRAT) transitions in order to improve wireless device and network performance. The minimization can take place per wireless device user, by leveraging geo-location information and/or per wireless device model using historical data. In either case, methods described herein improve end user experience by minimizing ping pong transitions across multiple RATs and by extending battery life of the wireless device. Further, systems and methods described herein improve network performance, for example by contributing to efficient capacity management of the unified data management (UDM) of the core network.

Currently, efforts to enhance wireless device performance across multiple RATS often result in unexpected service impacts due to excessive handovers, While these handovers may be due to the movement of devices, they also occur due to poor signal quality and the unavailability of services requested by devices on a particular RAT. Further, these handovers can be due to manufacturer settings for particular device models and network misconfigurations. Embodiments provided herein allow the handovers triggered by natural movement to take place, while minimizing handovers for stationary wireless devices due to the other above-mentioned factors.

Typically, IRAT transitions occur between a newer RAT and an older more mature RAT. For example, IRAT transitions may occur between 5G RATs and 4G RATs. In this example, the 4G RAT is the more mature RAT having more highly evolved service offerings and the 5G RAT is the newer RAT that offers additional services and other benefits such as increased speed and bandwidth. For example, while 5G RATs offer enhanced data services, they may not universally over voice services, such as voice over NR (VoNR), while 4G networks are able to reliably offer voice over LTE (VOLTE).

Generally speaking, wireless devices may be slow to evolve to be able to leverage newer RATs. For example, while most existing wireless devices are 4G capable, a smaller percentage of wireless devices are 5G capable. Of those wireless devices that are 5G capable, most are backwards compatible so that they may be subject to transitions between 4G and 5G RATs. With the evolution of 5G standalone (SA), in which the core network has a 5G service-based architecture (SBA), wireless devices transitioning between 4G and 5G RATs are transitioning between different core networks, which can be time and resource intensive.

Network operators strive to have devices utilize the newer RAT, e.g., 5G NRSA, which has increased benefits of larger bandwidths, increased speed, and network slicing. However, when devices are not capable of using the newer 5GNRSA RAT, they fall back to 4GLTE. This can be due to the innate incapability of the device, or the lack of a particular service, e.g., voice service or VoNR on the 5G NRSA RAT. Further, devices that are 5G capable often transition to 4G based on signal conditions differentials. All of these IRAT transitions require multiple communications between the wireless device, multiple base stations, and multiple core network components such as the 5G AMF and the 4G MME. The additional communication increases capacity requirements for core functions such as the UDM, making it difficult to maintain. It also results in poor user experience due to such IRAT ping-pongs. The communications is time and resource intensive and thus the IRAT transitions diminish the performance of both the wireless device and the network. Hence there is a need for intelligence to prevent such scenarios from happening unnecessarily.

Accordingly, systems, methods, and devices are proposed to enhance existing network processes and components now configured to have service-specific handover thresholds to support a RAT assignment policy for minimizing IRAT transitions based on current and historical network behaviors and wireless device performance. Embodiments disclosed herein identify a threshold number of inter-RAT transitions for wireless devices and further identify a handover trigger for those devices experiencing the IRAT transitions. Based on the meeting of the threshold and the identified handover trigger, methods provided herein assign wireless devices to a particularly selected RAT in order to minimize IRAT transitions. Embodiments disclosed herein further leverage learned behaviors and performance parameters of wireless devices in order to optimize performance with strategic RAT assignment. For example, embodiments disclosed herein can be utilized to override default handover thresholds for unnecessary IRAT transitions.

In embodiments described herein, processing tasks may be performed at a core network or closer to the cellular customer in order to reduce network congestion and increase processing speed. For example, embodiments disclosed herein may be implemented the cellular base stations or other edge nodes. Through the use of systems, methods, and devices described herein, existing handover processes triggered through static thresholds can be overridden to allow for a flexible RAT assignment policy based the devices meeting a threshold number of IRAT transitions as well as an identified handover trigger.

In addition to the systems and methods described herein, the operations for minimizing IRAT transitions may be implemented as computer-readable instructions or methods, and processing nodes on the network for executing the instructions or methods. The processing node may include a processor included in the access node or a processor included in any controller node in the wireless network that is coupled to the access node.

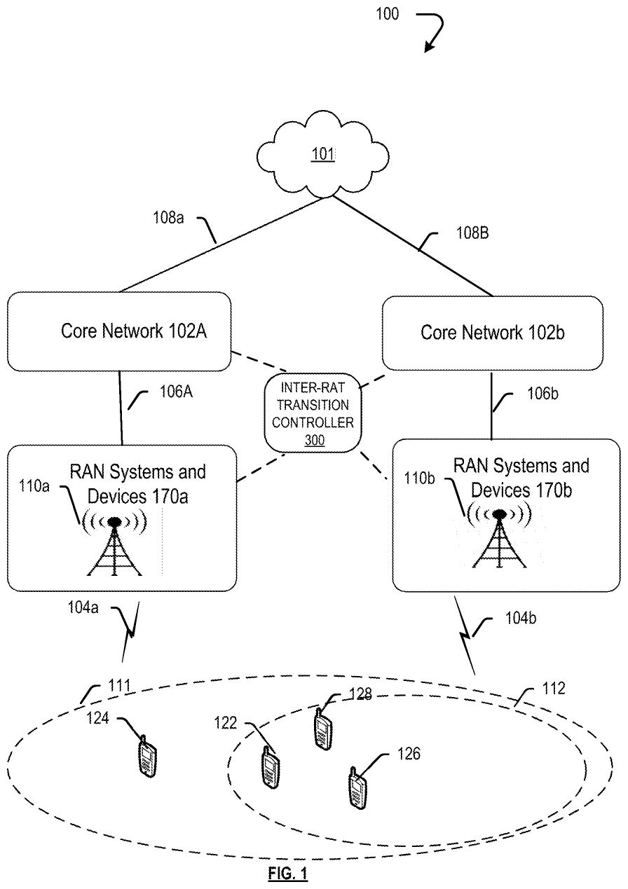

FIG. 1 depicts an exemplary system 100 for wireless communication, in accordance with the disclosed embodiments. The system 100 may include a communication network 101, multiple core networks 102a and 102b, and radio access networks (RANs) 170a and 170b, each including at least one access node 110a and 110b. The core networks 102a and 102b are connected to the communication network 101 over communication links 108a and 108b. The RANs 170a and 170b may include other devices and additional access nodes. The system 100 also includes multiple wireless devices 122, 124, 126, and 128, which may be end-user wireless devices and may operate within one or more coverage areas 111 and 112 and communicate with the RANs 170a and 170b over communication links 104a and 104b, which may for example be 5G NR and 4G LTE communication links.

The system 100 may further include an inter rat (IRAT) transition controller 300, which is illustrated as operating between the core networks 102a and 102b and the RANs 170a and 170b. However, it should be noted that the IRAT transition controller 300 may be distributed. For example, the IRAT transition controller 300 may utilize components located at both the core networks 102a and 102b, at multiple access nodes 110a and 110b and at the wireless devices 122, 124, 126, 128. Alternatively, the IRAT transition controller 300 may be an entirely discrete component operating between the core networks 102a, 102b and the RANs 170a and 170b.

The IRAT transition controller 300 receives information pertaining to IRAT transitions, wireless device type, wireless device travel and location and wireless device performance parameters. The wireless devices 122, 124, 126, and 128 further may send a type including a make and model and indicate a current service being utilized, e.g., VoNR to the IRAT transition controller 300.

The IRAT transition controller 300 analyzes this information for many wireless devices over time to develop a RAT assignment strategy for wireless devices experiencing a number of IRAT transitions exceeding a threshold within a predetermined time period. The RAT assignment strategy may involve identifying unnecessary IRAT transitions and avoiding the transitions for a predetermined time period, which may be selected and stored at the IRAT transition controller 300.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 122, 124, 126, 128. Wireless network protocols can comprise MBMS, code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

The core networks 102a and 102b include core network functions and elements. One core network, e.g. 102a, may have an evolved packet core (EPC) structure and the other core network, e.g. 102b may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QOS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 122, 124, 126, 128 and is responsible for handling connection and mobility management tasks. The SMF is primarily responsible for creating, updating, and removing sessions and managing session context. The UDM function provides services to other core functions, such as the AMF, SMF, and NEF. The UDM may function as a stateful message store, holding information in local memory. The NSSF can be used by the AMF to assist with the selection of network slice instances that will serve a particular device. Further, the NEF provides a mechanism for securely exposing services and features of the core network.

Although two core networks 102a and 102b are shown, a single core network 102 may be utilized that includes a distributed, cloud-native, converged core gateway instead of two distinct core networks. For example, the core networks 102a and 102b and 102b may include a cloud native converged core network including both 5GSA and 4G. Thus, the converged core gateway could connect a 4G LTE evolved packet core (EPC) to a 5G core network.

Communication links 106a, 106b and 108a, 108b can use various communication media, such as air, space, metal, optical fiber, or some other signal propagation path, including combinations thereof. Communication links 106a, 106b and 108a, 108b can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Other wireless protocols can also be used. Communication links 106a, 106b and 108a, 108b can be direct links or might include various equipment, intermediate components, systems, and networks, such as a cell site router, etc. Communication links 106a, 106b, 108a, and 108b may comprise many different signals sharing the same link. Communication links 106a, 106b, 108a, and 108b may be associated with many different reference points, such as N1-Nxx, as well as S1-Sxx, etc.

The RANs 170a and 10b may include various access network systems and devices such as access nodes 110a and 110b. The RANs 170a and 170b are disposed between the core networks 102a and 102b and the end-user wireless devices 122, 124, 126, 128. Components of the RANs 170a and 170b may communicate directly with the core networks 102a and 102b and others may communicate directly with the end user wireless devices 122, 124, 126, 128. The RANs 170a and 170b may provide services from the core networks 102a and 102b to the end-user wireless devices 122, 124, 126, and 128.

The RANs 170 includes at least an access node (or base station) 110, 120 such as an eNodeB 110a and a gNodeB 110b communicating with the plurality of end-user wireless devices 122, 124, 126, 128. It is understood that the disclosed technology may also be applied to communication between an end-user wireless device and other network resources, such as relay nodes, controller nodes, antennas, etc. Further, multiple access nodes may be utilized. For example, some wireless devices may communicate with an LTE eNodeB and others may communicate with an NR gNodeB. Further, although two RANs 170a and 170b are shown, additional RANs or a single combined RAN may be utilized.

Access nodes 110a, 110b can be, for example, standard access nodes such as a macro-cell access node, a base transceiver station, a radio base station, an eNodeB device, an enhanced eNodeB device, a gNodeB in 5G New Radio (“5G NR”), or the like. The gNBs may include, for example, centralized units (CUs) and distributed units (DUs).

In additional embodiments, access nodes may comprise two co-located cells, or antenna/transceiver combinations that are mounted on the same structure. Alternatively, access nodes 110a, 110b may comprise a short range, low power, small-cell access node such as a microcell access node, a picocell access node, a femtocell access node, or a home eNodeB device. As will be further described below, functionality for limiting unnecessary IRAT transitions may be included within the access nodes. Access nodes 110a, 110b can be configured to deploy one or more different carriers, utilizing one or more RATs. For example, a gNodeB may support NR and an eNodeB may provide LTE coverage. Any other combination of access nodes and carriers deployed therefrom may be evident to those having ordinary skill in the art in light of this disclosure.

The access nodes 110a, 110b can comprise a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Furthermore, in embodiments set forth herein, the access nodes 110a, 110b store default handover thresholds and existing handover rules. Further, in embodiments set forth herein, the access nodes 110a, 110b are able to interact with the IRAT transition controller 300 to minimize excessive IRAT transitions through strategic RAT selection and assignment.

The wireless devices 122, 124, 126, and 128 may include any wireless device included in a wireless network. For example, the term “wireless device” may include a relay node, which may communicate with an access node. The term “wireless device” may also include an end-user wireless device, which may communicate with the access node in the access network 170a, 170b through the relay node. The term “wireless device” may further include an end-user wireless device that communicates with the access node directly without being relayed by a relay node. In embodiments disclosed herein, the wireless devices 122, 124, 126, and 128 may be equipped with particular processing components to report relevant information to the IRAT transition controller 300, such as device location, device route, device speed, device type, and performance parameters. Further, the wireless devices may be equipped with logic to respond to instructions generated by the IRAT transition controller 300.

Wireless devices 122, 124, 126, and 128 may be any device, system, combination of devices, or other such communication platform capable of communicating wirelessly with access network 110 using one or more frequency bands and wireless carriers deployed therefrom. Each of wireless devices 122, 124, 126, and 128, may be, for example, a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless devices 122, 124, 126 128 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless devices 122, 124, 126, and 128. Wireless network protocols may include one or more of Multimedia Broadcast Multicast Services (MBMS), code division multiple access (CDMA) 1×RTT (radio transmission technology), Global System for Mobile communications (GSM), Universal Mobile Telecommunications System (UMTS), High-Speed Packet Access (HSPA), Evolution Data Optimized (EV-DO), Worldwide Interoperability for Microwave Access (WiMAX), Third Generation Partnership Project Long Term Evolution (3GPP LTE), Fourth Generation broadband cellular (4G, LTE Advanced, etc.), and Fifth Generation mobile networks or wireless systems (5G, 5G New Radio (“5G NR”), or 5G LTE). Wired network protocols utilized by communication network 101 may include one or more of Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the access networks 170a and 170b and the core networks 102a and 102b.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication system 100 may be, comprise, or include computers systems and/or processing nodes, including access nodes, controller nodes, and gateway nodes described herein.

The operations for minimizing unnecessary IRAT transitions may be implemented as computer-readable instructions or methods, and processing nodes on the network for executing the instructions or methods. The processing node may include a processor included in the access node or a processor included in any controller node in the wireless network that is coupled to the access node.

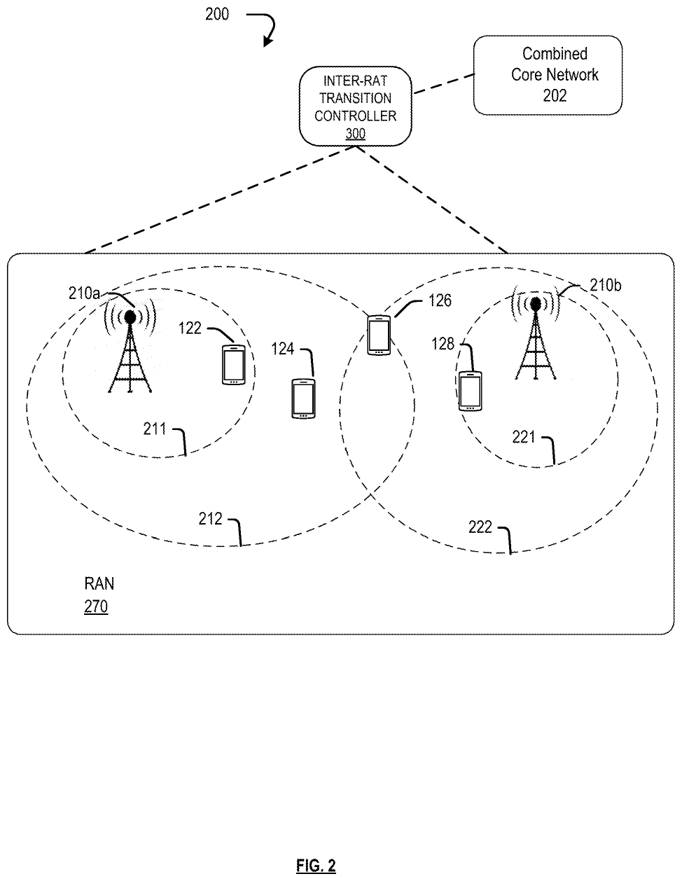

FIG. 2 depicts an exemplary operating environment 200 for an IRAT transition controller 300 accordance with the disclosed embodiments. The operating environment may include a RAN 270, which may include components for two different RATs. For example, the access nodes may include a combined eNB and gNB at both 210a and 210b. Thus both access nodes 210a and 210b operate using both 4G LTE and 5G NR. Wireless devices 122, 124, 126, and 128 may communicate over the RAN 270. The wireless devices 122, 124, 126, 128 may be end-user wireless devices and may operate within one or more coverage areas 211, 212, 221, and 222 of the access nodes 210a and 210b.

While like reference numbers may refer to the elements described above with respect to FIG. 1, the system 200 may include additional nodes similar to access nodes 210a and 210b. Further, these access nodes 210a and 220b may each operate within two different RATs and may thus each have two different coverage areas 211, 212, 221, and 222. For example, coverage area 211 may be a 5G coverage area of access node 210a and coverage area 212 may be a 4G LTE coverage area of the access node 210a. Further, a coverage area 221 may be a 5G coverage area of access node 210b and coverage area 222 may be a 4G LTE coverage area of access node 210b. As illustrated, the access nodes 210a and 210b may serve at least one wireless device 122, 124, 126, and 128 in the above-described coverage areas 211, 212, 221, and 222.

When both the access nodes 210a and 210b provide multi-RAT coverage through a co-located eNB and gNB, IRAT handovers may occur. For example, the wireless device 122 is shown as located within the coverage areas 211 and 212. The coverage area 211 may be, for example, a 5G NR coverage area, and the coverage area 212 may be, for example, a 4G LTE coverage area. Thus, the gNB may operate on a higher frequency than the eNB, but will have a lower coverage footprint and the eNB operates at a lower frequency band, but has a higher coverage footprint. While wireless devices 122, 124, 126, and 128 may be subject to IRAT handovers due to mobility, they may also be subject to IRAT handovers in other situations. In some cases, the wireless device 122 may be forced into an evolved packet system (EPS) fallback when the 5G NR coverage of the access node 210a cannot be provided. For example, if the wireless device 122 requests a voice call and the gNB does not offer voice service, the wireless device 122 will be released from 5G coverage and will re-select 4G coverage. Further, because the wireless device 122 is at the edge of the 5G coverage area 211, the signal quality of the 4G coverage area 212 may be better than that in the 5G coverage area. Thus, the wireless device 122 may also be subject to an EPS fallback in this situation, even if the wireless device 122 is not mobile. While this description pertains to a 5G to 4G handover, it should be understood that handovers can also occur in the reverse direction, from 4G to 5G. For example, the wireless device 128 may be handed over from 4G coverage provided in coverage area 222 to 5G coverage provided by coverage area 221. The handover may be due to mobility or to signal conditions being better for the 5G coverage than for the 4G coverage.

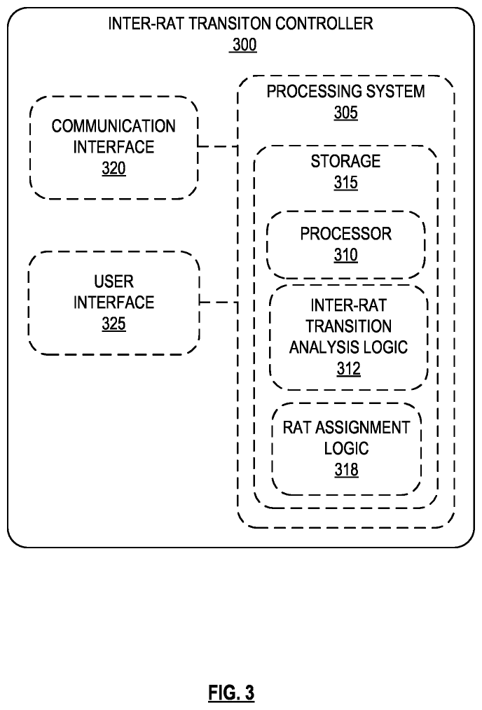

The IRAT controller 300 may be a separate component that communicates with the access nodes 210a and 210b and may also communicate with a converged core network 202. The IRAT 300 may be substantially as described herein with respect to FIG. 3 and may control whether the wireless devices 122, 124, 126, 128 operate in accordance with stored policies, for example, a default handover threshold stored at the access node, or whether the stored policies should be overridden for the wireless device 122, 124, 126, 128 in order to execute a RAT assignment policy to minimize IRAT handovers. For example, the IRAT transition controller 300 may accept existing thresholds unless a wireless device has been subject to repeated IRAT handovers during a predetermined durations, where the number of IRAT handovers meets a predetermined network threshold. In this instance the IRAT transition controller 300 may identify a handover trigger and implement a RAT assignment policy based on the handover trigger. Alternatively, the IRAT transition controller 300 may identify a device model and determine that the device model should be assigned to a predetermined RAT.

The IRAT transition controller 300 may further consider whether wireless devices are stationary, whether the wireless devices 122, 124, 126, 128 are using a particular service that is not available on all RATs, and whether the signal conditions for one RAT are better than the signal conditions for another. If the wireless device is not stationary, the IRAT transition controller 300 may allow standard or default handover thresholds stored at the access nodes 210a and 210b to take effect. However if the wireless devices are stationary, the IRAT handover may be deemed unnecessary.

FIG. 3 depicts an exemplary IRAT transition controller 300, which may be configured to perform the methods and operations disclosed herein to minimize unnecessary IRAT transitions. In the disclosed embodiments, the IRAT transition controller 300 may be integrated with the access node 110a, 110b, the core network 102a, 102b, 202 or may be an entirely separate component capable of communicating with the access nodes 110a, 110b, 210a, 210b, core network 102a, 102b, 202 and or the wireless devices 122, 124, 126, 128.

The IRAT transition controller 300 may be configured to minimize unnecessary IRAT transitions. To derive a RAT assignment plan, the IRAT transition controller 300 may include a processing system 305. Processing system 305 may include a processor 310 and a storage device 315. Storage device 315 may include a disk drive, a flash drive, a memory, or other storage device configured to store data and/or computer readable instructions or codes (e.g., software). The computer executable instructions or codes may be accessed and executed by processor 310 to perform various methods disclosed herein. Software stored in storage device 315 may include computer programs, firmware, or other form of machine-readable instructions, including an operating system, utilities, drivers, network interfaces, applications, or other type of software. For example, software stored in storage device 315 may include one or more modules for performing various operations described herein. For example, instructions 312 may be provided to monitor and analyze wireless device IRAT handovers to determine if the handovers are necessary and if the number of handovers meets a predetermined threshold within a predetermined time period. Further, instructions may be provided to evaluate whether a wireless device having a number of handovers exceeding the threshold is stationary or mobile. When the wireless device is stationary, IRAT transition controller 300 may determine that the handovers are unnecessary and may determine a trigger for the handovers and formulate a RAT assignment plan based on the trigger using RAT assignment logic 318 in order minimize unnecessary IRAT handovers. Processor 310 may be a microprocessor and may include hardware circuitry and/or embedded codes configured to retrieve and execute software stored in storage device 315.

The IRAT transition controller 300 may include a communication interface 320 and a user interface 325. Communication interface 320 may be configured to enable the processing system 305 to communicate with other components, nodes, or devices in the wireless network. For example, the IRAT transition controller 300 can share intelligence including the RAT assignment logic 318 with the access nodes 110a, 110b, 210a, and 210b.

Communication interface 320 may include hardware components, such as network communication ports, devices, routers, wires, antenna, transceivers, etc. User interface 325 may be configured to allow a user to provide input to the IRAT transition controller 300 and receive data or information from the IRAT transition controller 300. User interface 325 may include hardware components, such as touch screens, buttons, displays, speakers, etc. The IRAT transition controller 300 may further include other components such as a power management unit, a control interface unit, etc.

The IRAT transition controller 300 thus may utilize the memory 315 and the processor 310 to perform multiple operations. For example, the processor 310 may access stored instructions in the memory 310 to determine a number of IRAT handovers within a predetermined time period, whether the wireless device is mobile or stationary, if the wireless device is using a particular service, and a handover trigger for the wireless device. The IRAT transition controller 300 may accept or override stored handover instructions based and perform RAT assignment based on these operations.

The location of the IRAT transition controller 300 may depend upon the network architecture. For example, in smaller networks, a single IRAT transition controller 300 may be disposed for communication with wireless devices and access nodes shown in FIGS. 1 and 2. However, in a larger network, multiple IRAT transition controllers 300 may be required to cover the network. Further, the functions of the IRAT transition controller 300 may be split between the core network 102a, 102b, 202 and the RAN 170a, 170b, 270.

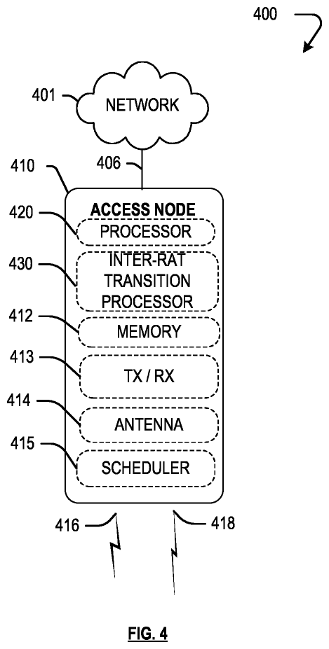

FIG. 4 illustrates an operating environment 400 for an exemplary access node 410 in accordance with the disclosed embodiments. In exemplary embodiments, the access node 410 is able to interact effectively with the IRAT transition controller 300 to minimize unnecessary IRAT transitions. The access node 410 can include, for example, a gNodeB or an eNodeB or a co-located eNB/gNB. Access node 410 may comprise, for example, a macro-cell access node, such as access node 110a, 110b, 210a, 210b described with reference to FIGS. 1 and 2. Access node 410 is illustrated as comprising a processor 420, an IRAT transition processor 430, a memory 412, transceiver(s) 413, and antenna(s) 414. Processor 420 executes instructions stored on memory 412, while transceiver(s) 413 and antenna(s) 414 enable wireless communication with other network nodes, such as wireless devices and other nodes. For example, wireless devices may initiate uplink transmissions such that the transceivers 413 and antennas 414 receive messages including, for example, route information and performance parameters from the wireless devices, for example, over communication links 416 and 418. The transceivers 413 and antennas 414 may further pass the messages to a mobility entity in the core network. Further, the transceivers 413 and antennas 414 receive signals from the mobility entity such as a mobility management entity (MME) or access and mobility function (AMF) and pass the messages to the appropriate wireless device. Scheduler 415 may be provided for scheduling resources based on the presence and performance parameters of the wireless devices as well as based on policies transmitted from the core network 102a, 102b, 202. Network 401 may be similar to the network 101 discussed above with respect to FIG. 1.

In embodiments provided herein, processor 420 may operate in conjunction with scheduler 415 and IRAT transition processor 430 to minimize unnecessary IRAT transitions. In operation, the IRAT transition processor 430 may be integrated with the processor 420 or alternatively may comprise logic stored in the memory 412 to execute RAT assignment procedures. For example, the IRAT transition processor 430 may receive instructions from the IRAT transition controller 300 and may provide the received instructions to the wireless devices 122, 124, 126, 128. The IRAT transition processor 430 may further provide stored default handover thresholds as well as a number of IRAT transitions during a predetermined time period per wireless device 122, 124, 126, and 128 to the IRAT transition controller 300.

While the processor 420, the IRAT transition processor 430, and the scheduler 415 are shown as separate components, these components may optionally be integrated in various combinations. For example, the processor 420 may perform the functions described above with respect to the IRAT transition processor 430 by accessing stored instructions from the memory 412. Further, the memory 412 may store service specific information, such as quality of service (QOS) requirements, timers, and thresholds. The stored thresholds may, for example, be default thresholds for handovers or a threshold for a number of handovers permitted to occur within a predetermined time period.

The access node 410 may utilize transceivers 413 and antennas 414 to communicate information, for example with the wireless devices 122, 124, 126, 128 and with the core networks 102a and 102b. For example, these components may receive requests from the wireless devices 122, 124, 126, 128 and further may receive instructions, such as RAT assignments, from the core networks 102a, 102b and the IRAT transition controller 300.

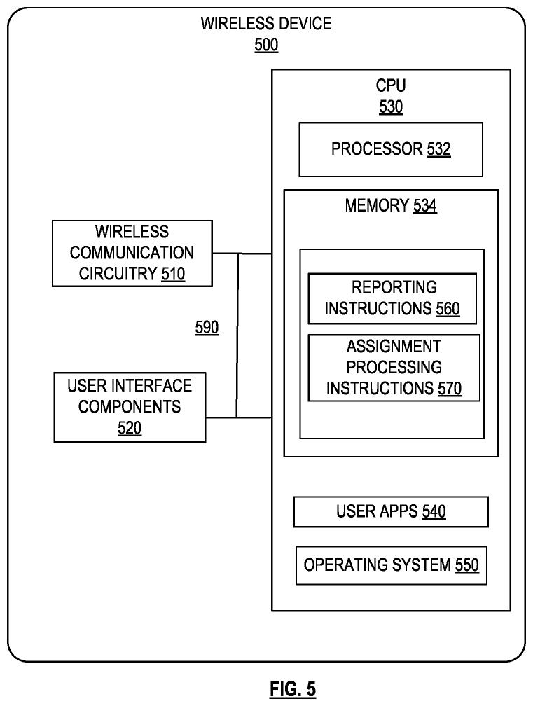

FIG. 5 depicts a wireless device (UE) 500 in accordance with disclosed embodiments. The wireless device 500 may correspond to one of wireless devices 122, 124, 126, 128 in FIG. 1 or 122, 124, 126, 128 in FIG. 2. As illustrated, the wireless device 500 includes wireless communication circuitry 510, user interface components 520, a central processing unit (CPU) 530, processor 532, memory 534, user apps 540, and operating system 550. Components may be connected, for example, by a bus 590. These components are merely exemplary and the wireless device 500 may include a larger or smaller number of components capable of performing the functions described herein. Wireless devices such as smartphones may have multiple microprocessors and microcontrollers. A microprocessor may have a bus to communicate with memory on separate chips and buses to communicate with the rest of the equipment. Alternatively or additionally, the mobile phone may include a System On a Chip (SoC).

The memory 534 may store, for example, reporting instructions 560 and assignment processing instructions 570. When executed by the processor 532, the programming shown interacts with the IRAT transition controller 300 to assist with the methods described herein.

The reporting instructions 560 may cause the wireless device 500 to report its performance parameters, travel path, make and model, and other information to the IRAT transition controller 300. For example, the wireless device 500 may report a location to indicate whether it is stationary or in motion. Further the wireless device reporting instructions may cause the wireless device 500 to report signal to noise and interference ratio (SINR), reference signal received power (RSRP), reference signal received quality (RSRQ), or other signal strength indicators. Additionally, the wireless device 500 may report its make and model (e.g., iPhone® or Android® 8, 10, 14, etc.) as well as the service it is currently using, e.g., VoNR. Further, the RAT assignment processing instructions 570 may cause the wireless device 500 to execute a handover or to remain connected to a particular RAT for a predetermined duration in accordance with instructions formulated by the IRAT transition controller 300 and received from the access node 410.

The wireless communication circuitry 510 may include circuit elements configured to generate wireless signals (e.g., one or more antennas) as well as interface elements configured, for example, to translate control signals from the CPU 530 into data signals for wireless output. Further, the wireless communication circuitry 510 may include multiple elements, for example to communicate in different modes with different RATs. The CPU 530 may be configured to receive, interpret, and/or respond to signals received via the wireless communication circuitry 510. The CPU 530 may be configured to receive a network command (e.g., from an access node 410 or from the IRAT transition controller 300) to perform other specified functions. The user interface components 520 may be or include any components enabling a user to interact with the wireless device 500.

The methods, systems, devices, networks, access nodes, and equipment described herein may be implemented with, contain, or be executed by one or more computer systems and/or processing nodes. The methods described above may also be stored on a non-transitory computer readable medium. Many of the elements of communication systems 100 or 200 may be, comprise, or include computers systems and/or processing nodes, including access nodes, controller nodes, and gateway nodes described herein.

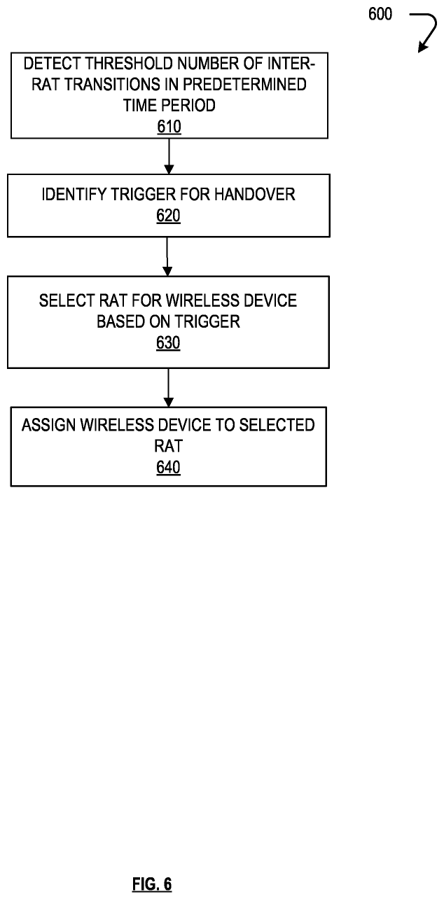

The disclosed methods for minimizing IRAT transitions are discussed further below. FIG. 6 illustrates an exemplary method 600 for minimizing IRAT transitions. Method 600 may be performed by any suitable processor discussed herein, for example, a processor 310 included in the IRAT transition controller 300. For discussion purposes, as an example, method 600 is described as being performed by the processor 310 of the IRAT transition controller 300.

Method 600 begins in step 610, when the IRAT transition controller 300 monitors IRAT transitions for multiple wireless devices 122, 124, 126, 128. For example, the access node 410 may report IRAT transitions to the IRAT transition controller 300 for the wireless devices 122, 124, 126, and 128. The processor 310 of the IRAT transition controller 300 may count the number of transitions for each wireless device occurring within a preset time period, for example, one hour, or thirty minutes. The IRAT transition controller 300 may store a threshold number of transitions, for example, five transitions, that may occur within this pre-set time period. The IRAT transition controller 300 may compare the counted number of transitions to the stored threshold number.

If the number of transitions meets or exceeds this stored threshold number, the processor 310 may further identify a trigger for the handovers in step 620. The trigger may be, or include for example, a signal-related trigger, availability of a service, OEM settings for a particular device model, or a network misconfiguration.

In embodiments set forth herein, the wireless devices 122, 124, 126, 128 further may send a type including a make and model and indicate a current service being utilized, e.g., voice or data service. The wireless devices 122, 124, 126, 128 further may send performance parameters may include one or more of SINR, RSRP, and RSRQ. Accordingly, the triggers can often be identified by information sent from the wireless devices 122, 124, 126, and 128.

In step 630, the IRAT transition controller 300 may consider the trigger in formulating a RAT assignment strategy for the wireless device. Thus, the selected RAT may differ depending upon what triggered the transition. It should be noted that in embodiments set forth herein, if the trigger is related to the trajectory of the wireless device, the processor 310 may allow default handover thresholds to be utilized instead of proceeding with a RAT selection. Specifically, the RAT selection may only occur for reporting wireless devices that are stationary. For example, the wireless devices 122, 124, 126, 128 may report their coordinates and the RAT selection may only be performed when the reported coordinates remain the same during the reported IRAT transitions described below. Thus, the IRAT transition controller 300 may monitor a location of the wireless device within a network and determine that the wireless device is stationary before proceeding with identifying a trigger in step 630. Location may be monitored for example by geo-location, triangulation, receiving coordinates from GPS enabled wireless devices, and/or a static RSRP over time. Other methods may also be used.

IRAT transitions may be triggered by various conditions. For example, if the trigger is related to unavailability of a service, the processor 310 selects a RAT that offers the available service. If the trigger is signal quality, the processor 310 selects the RAT with better signal conditions as long as the quality difference exceeds a predetermined threshold. If the signal quality differential between RATs does not exceed the predetermined threshold, then the processor 310 may select the RAT having greater bandwidth as long as the bandwidth differential exceeds a particular differential. If the bandwidth differential does not exceed the particular differential, the processor 310 may select the RAT with the most contiguous coverage as defined by the network operator. Additionally, the processor 310 may identify the trigger as being related to particular device manufacturer and model. In this instance the processor 310 may select the more mature RAT to ensure that the device has access to all services. In addition to selecting the more mature RAT, the processor 310 may provide an instruction to disable support of the less mature RAT at the wireless device 122,124, 126, 128, where the support may have been set by the device manufacturer.

In step 640, the processor 310 assigns the wireless device to the selected RAT. The assignment may occur when the processor 310 sends an instruction to the servicing access node. The access node serving the wireless device 122, 124, 126, 128 may send an instruction to the wireless device 122, 124, 126, 128. Thus, in embodiments provided herein, the processor 310 minimizes IRAT transitions with the RAT selection and assignment. Thus, the wireless devices 122, 124, 126, 128 are instructed in a manner calculated to avoid the negative experience of multiple handovers and service interruptions.

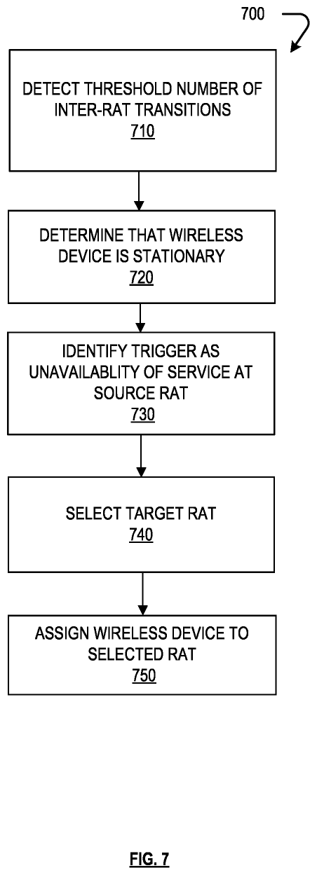

FIG. 7 illustrates an exemplary method 700 for minimizing IRAT transitions and in particular, FIG. 7 illustrates details of selecting a RAT in accordance with disclosed embodiments. Method 700 may be performed by any suitable processor discussed herein, for example, a processor 310 included in the IRAT transition controller 300. For discussion purposes, as an example, method 700 is described as being performed by the processor 310 of the IRAT transition controller 300 based on a request from the wireless device 122 to the access node 410.

Method 700 begins in step 710, when the IRAT transition controller 300 detects a threshold number of IRAT transitions for a wireless device 122. For example, the access node 410 may report IRAT transitions to the IRAT transition controller 300 for the wireless device 122. The processor 310 of the IRAT transition controller 300 may count the number of transitions for each wireless device occurring within a preset time period, for example, one hour, or thirty minutes. The IRAT transition controller 300 may store a threshold number of transitions, for example, five transitions, that may occur within this pre-set time period. The IRAT transition controller 300 may compare the counted number of transitions to the stored threshold number.

If the number of transitions meets or exceeds this stored threshold number in step 710, the method proceeds to step 720 to determine whether the wireless device 122 is stationary. The determination of whether the wireless device is stationary may be based on reporting from the wireless device 122 to the access node 410. The reporting may include, for example, GPS coordinates over the reporting time period.

Upon determination that the wireless device 122 is stationary in step 720, the processor 310 identifies the IRAT transitions as unnecessary and identifies a trigger at a source RAT as unavailability of a service in step 730. For example, if the source RAT is a 5G NR RAT without voice service, and the wireless device 122 requests voice service, the processor 310 determines that the trigger for the handover to a target RAT, e.g., 4G LTE, is unavailability of voice service at step 730 in the 5G NRSA RAT. Thus, the IRAT transition controller 300 identifies the trigger as unavailability of a service on a source RAT and finds that the service is available on a target RAT. In the above-described example, the service is voice service, which is unavailable on a 5G source RAT but is available on a 4G target RAT.

Accordingly, the IRAT transition controller 300 identifies the service as unavailable and seeks to select a mature RAT where all services are available for the wireless device 122. Thus, because unavailability of a desired service has been identified in step 730, the processor 310 selects the target RAT or 4G LTE as the RAT for the wireless device 122 requesting the service in step 740. In step 750, the processor 310 assigns the wireless device 122 to the RAT offering the requested service, for example, by sending an instruction to the wireless device 122. The assignment may further occur when the processor 310 sends an instruction to the servicing access node 410 and the serving access node 410 sends the instruction to the wireless device 122. Further, the IRAT transition controller 300 may assign the wireless device 122 to the selected RAT for a predetermined duration of time. The assignment may be accomplished extending an idle mode priorities duration. By assigning the wireless device 122 to the RAT offering the requested service in step 750, the processor 310 minimizes unnecessary IRAT transitions for the wireless device 122.

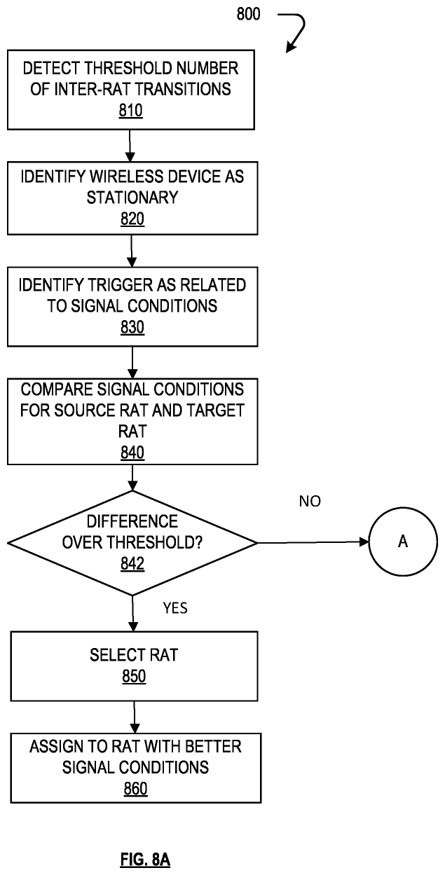

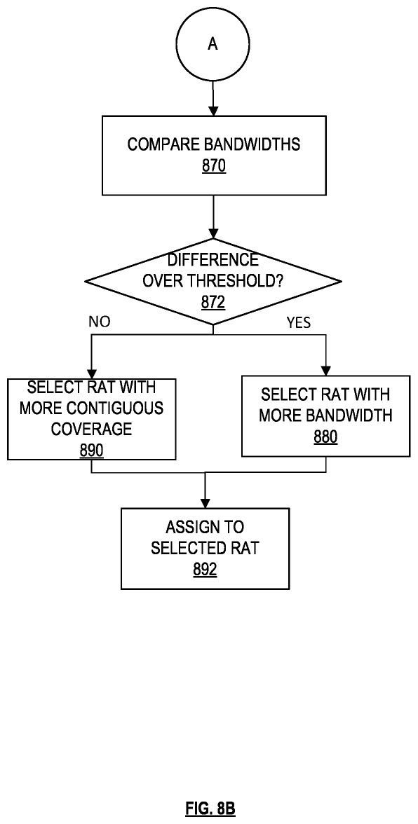

FIG. 8A illustrates an exemplary method 800 for minimizing IRAT transitions and in particular for minimizing IRAT transitions when the transitions are due to signal conditions. Method 800 may be performed by any suitable processor discussed herein, for example, a processor 310 included in the IRAT transition controller 300. For discussion purposes, as an example, method 800 is described as being performed by the processor 310 of the IRAT transition controller 300 in conjunction with the wireless device 128 and the access node 210b.

Method 800 begins in step 810, when the IRAT transition controller 300 monitors IRAT transitions for the wireless device 128. For example, the access node 210b may report IRAT transitions to the IRAT transition controller 300 for the wireless device 128. The processor 310 of the IRAT transition controller 300 may count the number of transitions for the wireless device 228 occurring within a preset time period, for example, one hour, or thirty minutes. The IRAT transition controller 300 may store a threshold number of transitions, for example, three transitions, that may occur within this pre-set time period. The IRAT transition controller 300 may compare the counted number of transitions to the stored threshold number.

If the number of transitions meets or exceeds this stored threshold number, the processor 310 may further identify the wireless device 128 as stationary in step 820. The determination of whether the wireless device is stationary may be based on reporting from the wireless device 128 to the access node 410. The reporting may include, for example, GPS coordinates over the reporting time period.

Upon determination that the wireless device 128 is stationary in step 820, the processor 310 deems the IRAT transitions unnecessary. The processor 310 may identify a trigger for the transitions as related to signal conditions in step 830. The signal condition trigger may be determined based on reporting from the wireless device 128. The wireless devices 128 may send performance parameters including one or more of SINR, RSRP, block error rate (BLER) and RSRQ to the access node 410. Accordingly, the signal condition trigger triggers can often be identified by information sent from the wireless device 128.

In step 840, the IRAT transition controller 300 may compare signal conditions for a source RAT and a target RAT. The source RAT may be the original RAT for the wireless device 128 and the target RAT may be the handover recipient. However, the selection of which RAT is the source RAT and which is the target RAT may be time dependent and therefore may vary. The processor 310 may access information from the network and/or information reported by the wireless device 128 in order to compare the signal conditions in the location of the wireless device 128.

In embodiments provided herein, the processor 310 identifies the target RAT as the selected RAT when the signal conditions of the target RAT are better than the signal conditions of the source RAT and identifies the source RAT as the selected RAT when the signal conditions of the source RAT are better than the signal conditions of the target RAT. However, a threshold differential may also be considered. In step 850, the processor 310 may determine if the difference in the signal conditions for the source RAT and target RAT are over a predetermined threshold, which may be stored at the IRAT transition controller 300. If the difference is over the predetermined threshold in step 850, the processor 310 assigns the wireless device 128 to the RAT with better signal conditions. The assignment may be accomplished, for example, by sending an instruction to the access node 410, which then provides an instruction to the wireless device 128.

However, if in step 850, the signal condition differential does not meet the threshold, the RAT selection process proceeds to FIG. 8B and step 870. In step 870, the processor 310 compares bandwidths of the source RAT and target RAT. Thus, in embodiments provided herein, the processor 310 compares a bandwidth of the source RAT to a bandwidth of the target RAT when the signal conditions within the source and target RATs are within a predetermined threshold difference and identifies the RAT having a larger bandwidth as the selected RAT. However, the bandwidth differential may also be evaluated based on a predetermined network threshold.

In step 872, the processor 310 determines if the difference between bandwidths is over the predetermined network selected threshold, which may be stored in the IRAT transition controller 300. If the difference in bandwidths is over the threshold in step 872, the processor 310 selects the RAT with greater bandwidth in step 880.

However if the difference is not over the threshold in step 872, the processor 310 selects the RAT with more contiguous coverage in step 890. Thus, the processor 310 may identify a RAT having more contiguous coverage as the selected RAT when the bandwidths are substantially equal.

Finally, in step 892, the processor 310 assigns the wireless device 128 to the selected RAT in step 892. The assignment may be performed for example when the processor 310 sends an instruction to the servicing access node 410 and the serving access node 410 sends the instruction to the wireless device 128. By assigning the wireless device 128 to the RAT offering bandwidth advantages, the processor 310 minimizes IRAT handovers for the wireless device 128.

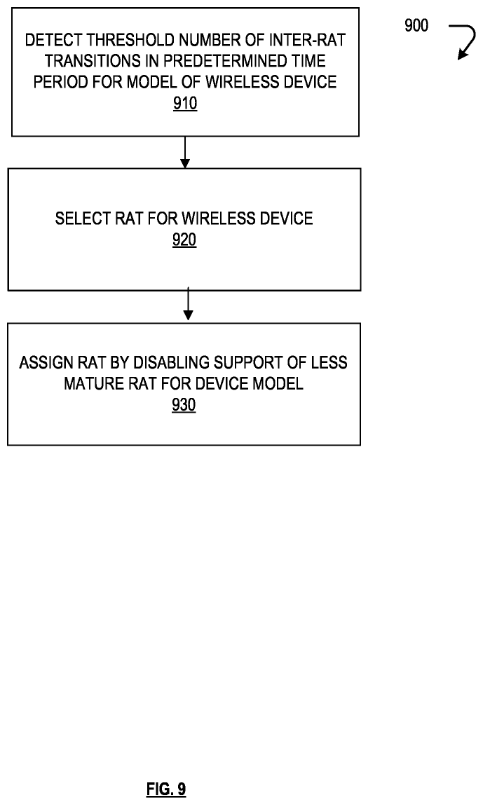

FIG. 9 illustrates an exemplary method 900 for minimizing IRAT transitions in accordance with a further embodiment. Method 900 may be performed by any suitable processor discussed herein, for example, a processor 310 included in the IRAT transition controller 300. For discussion purposes, as an example, method 900 is described as being performed by the processor 310 of the IRAT transition controller 300 for the wireless device 222 communicating with the access node 210a.

Method 900 begins in step 910, when the IRAT transition controller 300 monitors IRAT transitions for the wireless device 122. For example, the access node 410 may report IRAT transitions to the IRAT transition controller 300 for the wireless device 122. The processor 310 of the IRAT transition controller 300 may count the number of transitions for each wireless device occurring within a preset time period, for example, one hour, or thirty minutes. The IRAT transition controller 300 may store a threshold number of transitions, for example, five transitions, that may occur within this pre-set time period. The IRAT transition controller 300 may compare the counted number of transitions to the stored threshold number. If the number of transitions meets or exceeds this stored threshold number, the processor 310 may further identify a network misconfiguration or a model of wireless device as a trigger for the handovers in step 920. In this instance, the trigger is related to OEM settings for a particular device model.

The processor 310 may identify the model and make of a wireless device as the trigger based on historical information stored in a memory of the IRAT controller 300. Further, the processor 310 may be aware of the make and model of the wireless device 122 based on notifications sent to the access node 410 by the wireless device 122. In embodiments set forth herein, the wireless device 122 may send a type including its make, model, chipset, etc. to the access node 410. Certain OEMs, such as Apple®, have their own implementations regarding which RATs to select based on their Wi-Fi connections. For example, all iPhones® prefer 4G LTE when they are connected to Wi-Fi. However, if they are not connected to Wi-Fi, they prefer 5GSA.

Thus in step 930, the processor 310 may disable support of the less mature RAT for the device make and model. This may occur by sending an instruction to the wireless device 122 or alternatively, by instructing the access node to utilize only the more mature, legacy RAT with this particular make and model of device that is prone to IRAT transitions exceeding the threshold due to OEM settings. Further, in some embodiments, the IRAT transition controller may send an update to the core network, for example to the UDM in order to override on OEM RAT assignment. Additionally, the IRAT transition controller 300 may use a carrier configuration to disable support of an immature RAT. Further, the IRAT transition controller 300 may disable only a certain frequency band or layer of the immature RAT when these bands or layers are repeatedly implemented in unnecessary handovers. Thus, through step 930, the processor 310 both selects and assigns the more mature legacy RAT to the wireless device 122. In embodiments provided herein, the assignment may be for a limited time period. Thus, for the particular time period, unnecessary IRAT transitions for the wireless device 122 are eliminated.

Further, in all of the aforementioned embodiments, the IRAT transition controller 300 executes selection and assignment of a RAT. The particular configuration for making decisions and conveying an instruction may depend on the location of the IRAT transition controller 300 within the network. For example, IRAT transition controllers 300 could be located both at the core network 202 and closer to a network edge so that inquiries may be processed locally, but decision making occurs at the core network 202.

In some embodiments, methods 600, 700, 800, and 900 may include additional steps or operations. Furthermore, the methods may include steps shown in each of the other methods. As one of ordinary skill in the art would understand, the methods 600, 700, 800, and 900 may be integrated in any useful manner and the steps may be performed in any useful sequence.

In some embodiments, methods 600, 700, 800, and 900 may include additional or fewer steps or operations. Furthermore, the methods may include steps shown in each of the other methods. As one of ordinary skill in the art would understand, the methods 600, 700, 800, and 900 may be integrated in any useful manner. Further, the order of the steps shown is merely exemplary and the order of steps may be rearranged in any useful manner.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
determining that a wireless device has experienced a threshold number of inter-radio access technology (RAT) handovers in a predetermined time period;
identifying a trigger for the inter-RAT handovers; and
assigning the wireless device to a selected RAT based on the identified trigger.

2. The method of claim 1, further comprising monitoring a location of the wireless device within a network and determining the wireless device is stationary.

3. The method of claim 2, further comprising identifying the trigger as unavailability of a service on a source RAT, wherein the service is available on a target RAT and identifying the target RAT as the selected RAT.

4. The method of claim 3, wherein the service is voice service, the source RAT is 5G, and the selected RAT is 4G.

5. The method of claim 3, further comprising assigning the wireless device to the selected RAT for a predetermined duration of time.

6. The method of claim 1, wherein assigning the wireless device to the selected RAT comprises extending an idle mode priorities duration.

7. The method of claim 1, further comprising identifying the trigger as related to signal conditions.

8. The method of claim 7, further comprising comparing the signal conditions in a source RAT to the signal conditions in a target RAT.

9. The method of claim 8, further comprising identifying the target RAT as the selected RAT when the signal conditions of the target RAT are better than the signal conditions of the source RAT and identifying the source RAT as the selected RAT when the signal conditions of the source RAT are better than the signal conditions of the target RAT.

10. The method of claim 8, further comprising comparing a bandwidth of the source RAT to a bandwidth of the target RAT when the signal conditions within the source and target RATs are within a predetermined threshold difference and identifying the RAT having a larger bandwidth as the selected RAT.

11. The method of claim 10, further comprising identifying a RAT having more contiguous coverage as the selected RAT when the bandwidths are substantially equal.

12. The method of claim 1, further comprising identifying the trigger as related to a device model.

13. The method of claim 12, further comprising disabling support of an immature RAT for the device model.

14. A system comprising:
a memory storing data and instructions;
a processor accessing the stored data and instructions and performing operations comprising;
determining that a wireless device has experienced a threshold number of inter-radio access technology (RAT) handovers in a predetermined time period;
identifying a trigger for the inter-RAT handovers, wherein the trigger is identified from one of unavailability of a service, signal conditions, and a wireless device model; and
assigning the wireless device to a selected RAT based on the identified trigger.

15. The system of claim 14, the operations further comprising monitoring a location of the wireless device within a network and determining the wireless device is stationary and identifying the trigger as the unavailability of a service on a source RAT, wherein the service is available on a target RAT, and identifying the target RAT as the selected RAT.

16. The system of claim 14, further comprising monitoring a location of the wireless device within a network and determining the wireless device is stationary, identifying the trigger as related to the signal conditions and identifying a target RAT as the selected RAT when the signal conditions of the target RAT are better than the signal conditions of a source RAT and identifying the source RAT as the selected RAT with the signal conditions of the source RAT are better than the signal conditions of the target RAT.

17. The system of claim 16, the operations further comprising comparing a bandwidth of the source RAT to a bandwidth of the target RAT when the signal conditions within the source and target RATs are within a predetermined threshold difference and identifying the RAT having a larger bandwidth as the selected RAT.

18. The system of claim 14, the operations further comprising identifying the trigger as related to the wireless device model and disabling support of an immature RAT for the wireless device model.

19. A non-transitory computer-readable medium storing instructions for execution by a processor to perform operations including:
determining that a wireless device has experienced a threshold number of inter-radio access technology (RAT) handovers in a predetermined time period;
identifying a trigger for the inter-RAT handovers; and
assigning the wireless device to a selected RAT based on the identified trigger.

20. The non-transitory computer-readable medium of claim 19, the operations further including identifying the trigger as being one of signal quality, an unavailable service, and a wireless device model.
